(19) United States
(12) Patent Application Publication
(10) Pub. No.: US 2010/0307352 A1
(43) Pub. Date: Dec. 9, 2010

(54) KEYBOARD THERMAL TRANSFER PRINTER

(76) Inventor: KUO-CHENG HUANG, Wu-Feng Hsiang (TW)

Correspondence Address: PHILLIP LIU, 6980, WHITEOAK DRIVE, RICHMOND, BC, V7E 4Z9, CA

(21) Appl. No.: 12/480,584

(22) Filed: Jun. 8, 2009

(51) Int. Cl. B41F 19/02

(52) U.S. Cl. 101/27

(57) ABSTRACT

A keyboard thermal transfer printer is provided under the working platform of the keyboard thermal transfer printer with a translation drive having an electrically driven ball screw to precisely control the locating point of the lower working die seat on the working platform in a stepless driving manner. The longitudinal supports and load board of the working platform are constructed as a primary and an auxiliary work area, and respectively provided with a spindle system and an impression system. An infrared thermal sensor is disposed in the auxiliary work area to irradiate infrared rays on the press plate impression element and reflects the operating temperature of the impression element. The parameters of each function of the control box are corrected to obtain the optimum operating temperature for keyboard thermal transfer printing, thereby maintaining the consistency of the quality of images produced by keyboard surface thermal transfer printing.

### FIELD OF THE INVENTION

The present invention relates to a keyboard thermal transfer printer, and more particularly to a novel keyboard thermal transfer printer that can control the transfer printing quality of transfer printing films more precisely by the impression of press plates.

### BACKGROUND OF THE INVENTION

Thermal transfer printing technology is the most widely used in the technical field of thermal transfer printing. Its principle lies in that an image is previously printed on a transfer printing film and the transfer printing film is then printed on the surface of a work piece via a keyboard thermal transfer printer. Under mass production conditions, it possesses the advantage of easy and rapid production, as well as reduces the losses.

A repeatedly adjustable oil (pneumatic) cylinder is selected as the power element of a known thermal transfer printer for driving the heating platform to drive the rise and fall of the heating platform. The potential technical problems in driving the heating platform to repeatedly move linearly with an oil (pneumatic) cylinder power element include problems in terms of:

1. space occupation due to the volume of the oil (pneumatic) cylinder;

2. machine contamination due to oil leakage caused by the structural damage of an oil cylinder and inaccuracy in the driven position of the heating platform due to gas leakage caused by a broken or cracked pneumatic cylinder;

3. power consumption during the driving operation less satisfactory for the economic benefits;

4. poor precision due to a higher or lower position than an exact locating point easily caused by the driving of an oil (pneumatic) cylinder.

In addition to the technical problems of using an oil (pneumatic) cylinder as the power element, another long-existing problem in a conventional thermal transfer printer is the design of mechanical temperature detection during thermal transfer printing. Although there is only slight deterioration in the accuracy, the little bit of inaccuracy in temperature detection results in a higher or lower thermal transfer printing temperature, which brings a serious defect to the overall transfer printing quality. There is still promising improvement space for the power elements and the operating temperature detection of thermal transfer printers.

### SUMMARY OF THE INVENTION

The present invention principally provides an environmental protection keyboard thermal transfer printer without the occurrence of oil leakage, contamination and with low power consumption.

It is another object of the present invention to provide a keyboard thermal transfer printer that can precisely control the locating points of the upper and lower working die seats.

It is a further object of the present invention to provide a keyboard thermal transfer printer in which a press plate impression element can perform transfer print precisely on the keyboard by a press plate.

Another object of the present invention is to provide a novel keyboard thermal transfer printer that can really reflect the operating temperature of the press plate impression element and precisely control the thermal transfer printing temperature to obtain consistency of thermal transfer printing quality.

To achieve the above desired objects, a keyboard thermal transfer printer of the present invention is provided and mainly comprises a body which is provided with a working platform. A translation drive is disposed under the working platform. The translation drive is provided with an electrically driven ball screw that drives a lower working die seat on the working platform to repeatedly move linearly.

Several longitudinal supports extend vertically from the working platform surface. A load board bridges transversely between all the longitudinal supports. The load board is defined by the adjacent longitudinal supports into a set of primary and auxiliary work areas. A spindle system is disposed in the primary work area and an impression system is disposed in the auxiliary work area. The spindle system and the impression system are provided longitudinally with electrically driven ball screws penetrating through the load board. The ball screw of the spindle system is coupled to and drives an upper working die seat. The ball screw of the impression system is coupled to and drives a press plate impression element. The operating temperature on the surface of the impression element can be really reflected through an infrared thermal sensor that is disposed in the auxiliary work area and emits infrared rays without the effect of the surrounding environment so that precise temperature adjustment is possible during thermal transfer printing. The locating points of the upper and lower working die seats are precisely controlled by the actuation of the ball screws with the aid of the infrared thermal sensor capable of precisely detecting the temperature so that the above desired effects can be naturally achieved.

### BRIEF DESCRIPTION OF THE DRAWINGS

FIG. 1 is a schematic planar front view of a keyboard thermal transfer printer according to the present invention in a normal state when unactuated;

FIG. 1A is a schematic view of a press plate impression element of a keyboard thermal transfer printer according to the present invention;

FIG. 2 is a schematic planar side view of a keyboard thermal transfer printer according to the present invention in a normal state when unactuated;

FIG. 3 is a top view of a keyboard thermal transfer printer according to the present invention, and

FIG. 4 is a schematic view of an upper and a lower working die seat of a keyboard thermal transfer printer according to the present invention in an actuated state.

### DETAILED DESCRIPTION OF THE PREFERRED EMBODIMENTS

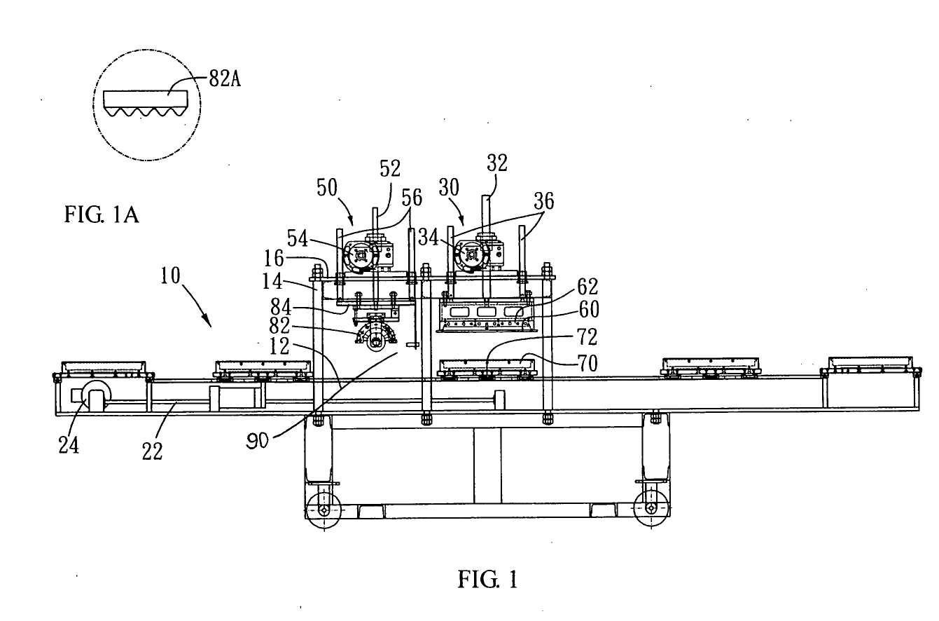

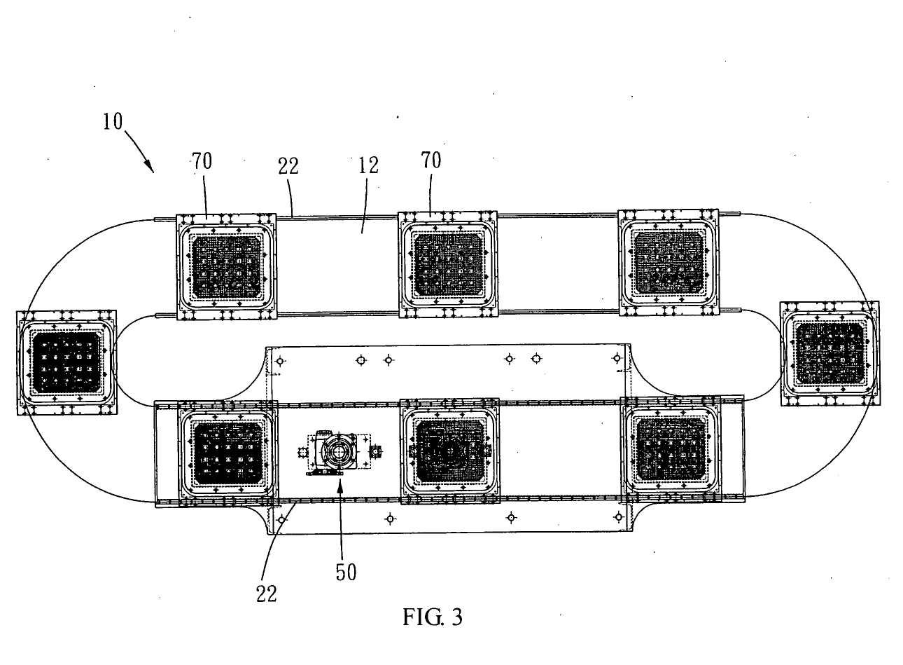

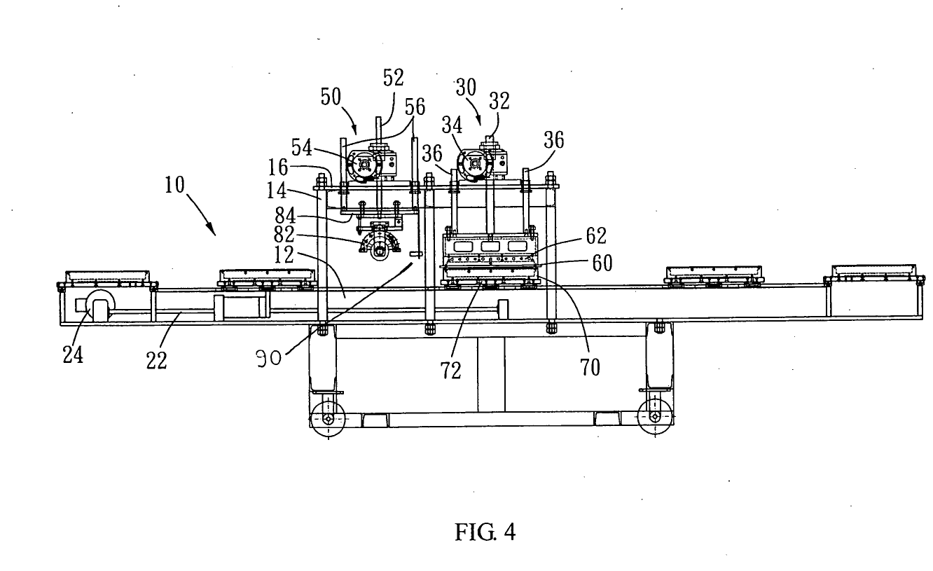

Preferred structural embodiments of the keyboard thermal transfer printer according to the present invention are as shown in FIGS. 1 to 4. The body 10 of the keyboard thermal transfer printer mainly comprises: a working platform 12, a translation drive, a spindle system 30 and an impression system 50, an upper working die seat 60, more than one lower working die seat 70, an impression element and an infrared thermal sensor 90.

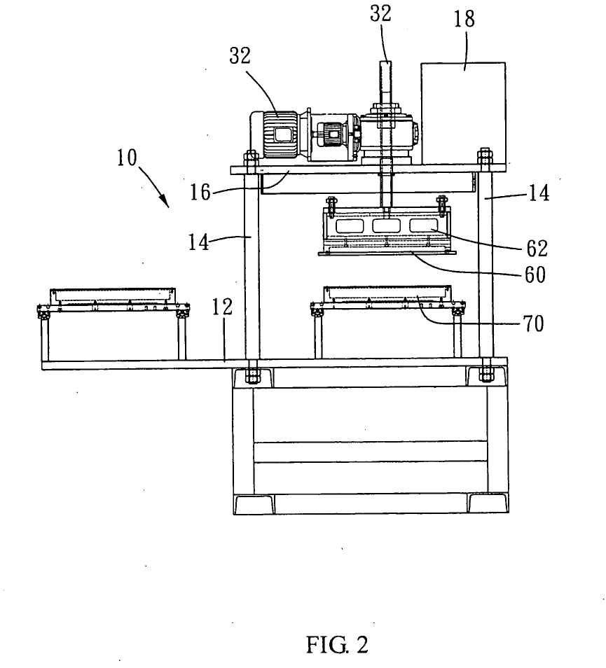

According to one aspect disclosed in FIG. 2, the working platform 12 is a continuous rotary platform (or may be a left-in-right-out straight platform). The working platform 12 is vertically upwardly provided at preset sites thereof with longitudinal supports 14 (the number of the longitudinal supports may optionally be increased or decreased). A load board 16 of a preset width bridges transversely between the top ends of all the longitudinal supports 14. A control box 18 is provided on the surface of the rear half of the load board 16 to control the operation of the keyboard thermal transfer printer. The load board is defined by the adjacent longitudinal supports into a set of primary and auxiliary work areas. The number of the foregoing primary and auxiliary work areas depends on the form the working platform 12. If merely a single thermal transfer print image is required for the product and a straight platform is employed, only one set of primary and auxiliary work areas is required on the working platform. On the contrary, if multiple thermal transfer print images are required for the single product disclosed in the figure, the rotary working platform disclosed in the figure can be used. The rotary platform can be alternatively provided with several sets of primary and auxiliary work areas (For the simplification of the figure, only one set of primary and auxiliary work areas are depicted for illustrating the structure of the technical feature of the present invention).

The translation drive is disposed under the working platform. It comprises a horizontal ball screw 22 arranged along the length direction of the working platform and a power source 24 (may be a common motor) driving the action of the horizontal ball screw.

The spindle system 30 is disposed in the primary work area. The impression system 50 is disposed in the auxiliary work area. The spindle system 30 and the impression system 50 mainly comprise: vertical ball screws 32, 52 penetrating longitudinally through the load board and power parts 34, 54 controlling the action of the vertical ball screws. The power part 34 of the spindle system is a 1 HP spindle motor. The power part 54 of the impression system is a servo motor. Two symmetric guide rods 36, 56 penetrating the load board 16 are respectively provided on the two adjacent sides of the ball screws in the above primary and auxiliary work areas.

The upper working die seat 60 is coupled to the bottom end of the vertical ball screw 32 and the bottom ends of the two guide rods of the spindle system for controlling the rise and fall thereof with the forward or backward rotation of the vertical ball screw. A preheating unit 62 in the aspect of a preheating chamber is disposed at the back of the upper working die seat.

The more than one lower working die seat 70 is disposed on the surface of the working platform and driven by the horizontal ball screw 22 to repeatedly move linearly along the working platform. A vacuum adsorption device 72 (e.g. a vacuum cup set) is disposed at the back of the lower working die seat.

The press plate as shown in FIG. 1A, is disposed at the center of a connecting member 82a. The connecting member is coupled respectively to the bottom end of the vertical ball screw 52 of the impression system and the bottom ends of the two guide rods 56 located on the two sides of the vertical ball screw 52 for driving the rise and fall thereof by the vertical ball screw. The guide rods 56 allow the impression element in the aspect of the press plate impression element to rise and fall such that it is limited by the guide rods and precisely moves linearly up and down.

The infrared thermal sensor 90 is disposed in the left and right work areas between the working platform and the load board. The infrared thermal sensor 90 emits infrared rays to irradiate the press plate impression element for detecting the actual operating temperature of the press plate impression element. The above-mentioned is a keyboard thermal transfer printer of the present invention.

In the actual operation, the keyboard thermal transfer printer comprised of the above mechanisms has the effects including:

(1) An electrically driven ball screw in combination with a frequency converter is used as the power source for driving the upper and lower working die seats to substitute a greasy, smudgy oil cylinder. With the aid of a frequency converter, a ball screw with better accuracy has the advantages of change speed control and increased actuation speed.

(2) An electrically driven ball screw with the aid of a frequency converter has the effect of stepless stop of actuation at a fixed point. It can provide the effect of controlling the precise superposition position of the lower working die seat on the working platform and the upper working die seat such that a transfer printing film can be transfer printed at a desired position on the surface of a work piece under compression of the upper and lower working die seats. Furthermore, the descending height of the upper working die seat can be precisely controlled by controlling the rise and fall thereof with the action of the vertical ball screw. This avoids the problem of a higher or lower position than a precise locating point easily caused by the driving of a traditional oil cylinder, thereby resulting in a problem that thermal transfer printing quality cannot remain consistent.

(3) An electrically driven ball screw serves as the power source for the upper and lower working die seats, it improves the inherent problems of maintenance and leakage caused by the structural damage of the conventional oil cylinder. The present invention also resolve the exist problem of the influence on positioning accuracy of the displacement due to gas leakage caused by a broken or cracked pneumatic cylinder. More importantly, the power consumption of a ball screw is less than that of conventional power sources so that the present invention meets the environmental protection requirement of energy saving and less carbon dioxide discharge.

(4) The impression element in the aspect of press plates can effectively perform a total thermal transfer printing process in a hot press manner to allow a complete thermal transfer printing result.

(5) The operating temperature of the press plate impression element is detected by using an infrared thermal sensor as a media, which can emit invisible infrared rays having a wavelength of 0.75 to 3 μm to directly irradiate the impression element with their wavelengths. The invisible infrared rays are not affected by the surrounding environment so as to really reflect the actual operating temperature of the impression element. It would be advantageous for users to control the transfer printing temperature of the keyboard thermal transfer printer according to the detected data, thereby controlling the quality of thermal transfer printing products.

While we have shown and described the embodiment in accordance with the present invention, it should be clear to those skilled in the art that further embodiments may be made without departing from the scope of the present invention.

What is claimed is:

1. A keyboard thermal transfer printer comprising:
a working platform vertically upwardly provided with several longitudinal supports, a load board bridging transversely between respective top ends of the longitudinal supports, the load board provided thereon with a control box and including into at least one set of primary and auxiliary work areas defined by the adjacent longitudinal supports;
a translation drive disposed under the working platform and comprising a horizontal ball screw arranged along a length direction of the working platform and a power source driving the horizontal ball screw;
a spindle system and an impression system, the spindle system being disposed in the primary work area, the impression system being disposed in the auxiliary work area, the spindle system and the impression system comprising a vertical ball screw which penetrates longitudinally through the load board, a power part controlling the vertical ball screw;
an upper working die seat coupled to a bottom end of the vertical ball screw of the spindle system for controlling rise and fall thereof with the vertical ball screw, a preheating unit being disposed at a back of the upper working die seat, a lower working die seat disposed on the surface of the working platform and driven by the horizontal ball screw to repeatedly move linearly along the working platform, a vacuum adsorption device being disposed at a back of the lower working die seat;
a press plate impression element coupled to a connecting member which is disposed at the bottom end of the vertical ball screw of the impression system for driving rise and fall thereof with the vertical ball screw; and
an infrared thermal sensor disposed in left and right work areas between the working platform and the load board, emitting infrared rays having a wavelength of 0.75 to 3 μm to irradiate the press plate impression element for detecting an operating temperature of the impression element.

2. The keyboard thermal transfer printer as claimed in claim 1, wherein a power part of the spindle system is a spindle motor and a power part of the impression system is a servo motor.

3. The keyboard thermal transfer printer as claimed in claim 1, wherein two symmetric guide rods penetrating the load board are provided on two sides of the ball screw, two respective bottom ends of the two guide rods in the central work area are coupled to the upper working die seat and two respective bottom ends of the two guide rods in the auxiliary work area are coupled to the connecting member.

4. The keyboard thermal transfer printer as claimed in claim 1, wherein the working platform is a closed rotary platform.

5. The keyboard thermal transfer printer as claimed in claim 3, wherein the working platform is a closed rotary platform.
